(19) United States
(12) Patent Application Publication
(10) Pub. No.: US 2009/0156061 A1
(43) Pub. Date: Jun. 18, 2009

(54) NON-LINEAR POWER OUTLET EXPANDER AND ASSOCIATED METHODS

(76) Inventor: Charlie Bernstein, Murray, UT (US)

Correspondence Address: THORPE NORTH & WESTERN, LLP., P.O. Box 1219, SANDY, UT, 84091-1219, US

(21) Appl. No.: 12/332,822

(22) Filed: Dec. 11, 2008

Related U.S. Application Data
(60) Provisional application No. 61/007,615, filed on Dec. 12, 2007.

(51) Int. Cl. H01R 25/00

(52) U.S. Cl. 439/652

(57) ABSTRACT

A multiple socket electrical outlet device includes a bell shaped housing having an arcuate side wall with a domed upper end and an outwardly flared lower end. The arcuate sidewall forms a perimeter around the bell shaped housing. A plurality of protrusions extends away from the sidewall. Each of the protrusions has a face oriented in a different radial direction around the perimeter of the bell shaped housing. An electrical socket is disposed in the face of each of the plurality of protrusions. The plurality of protrusions are positioned on the sidewall between the domed upper end and the outwardly flared lower end to form a depression between the arcuate side wall and each of the plurality of protrusions with the depression extending between each of the protrusions.

### PRIORITY CLAIM

Benefit is claimed of U.S. Provisional Patent Application No. 61/007,615, filed Dec. 12, 2007, which is herein incorporated by reference in its entirety for all purposes.

### BACKGROUND OF THE INVENTION

1. Field of the Invention

The present invention relates generally to power outlet expanders such as power strips, surge protectors and the like.

2. Related Art

Power outlet expanders, such as power strips, surge protectors, strip plugs, and the like expand the number of available electrical outlets of a typical dual receptacle power outlet, such as a wall plug. Such power outlet expanders are often arranged in the form of a single row, line, or strip of outlets with an extension cord extending from the row of outlets that can be plugged into an existing electrical socket.

Unfortunately, many power outlet expanders position the outlets too close together or orient each of the outlets such that plugging a power adapter or transformer into one of the sockets covers or blocks an adjacent socket rendering the covered socket unusable while the power adapter or transformer is plugged into the expander. Additionally, many power outlet expanders have a larger socket face than the plug-in adapters or transformers which can make the plug-in adapter difficult to grasp and remove from the power outlet expander.

### SUMMARY OF THE INVENTION

The inventor of the present invention has recognized that it would be advantageous to develop a power outlet expander having sufficient space and orientation to couple multiple power adapters or transformers to the expander while minimizing interference between the adapters. Additionally, the inventor has recognized that it would be advantageous to develop a power outlet expander that facilitates grasping and removing the adapter or transformer.

The present invention provides for a multiple socket electrical outlet device including a bell shaped housing having an arcuate side wall with a domed upper end and a outwardly flared lower end. The arcuate sidewall can form a perimeter around the bell shaped housing. A plurality of protrusions extends away from the sidewall. Each of the protrusions can have a face oriented in a different radial direction around the perimeter of the bell shaped housing. An electrical socket can be disposed in the face of each of the plurality of protrusions. The electrical sockets are configured to receive an electrical plug. The plurality of protrusions can be positioned on the sidewall between the domed upper end and the outwardly flared lower end to form a depression between the arcuate side wall and each of the plurality of protrusions with the depression extending between each of the protrusions.

In another aspect, the multiple electrical socket device can have a base disposed under the outwardly flared lower end. The base can have perimeter relatively smaller than the flared lower end. A power cord can extend from a side of the base that is electrically coupled to the sockets. The power cord can be coupled to a power supply to provide power to the sockets.

In yet another aspect, the multiple electrical socket device can have a male electrical plug electrically coupled to the plurality of sockets and disposed in the lower end of the device. The electrical plug can be configured to plug into an electrical power receptacle to receive electricity therefrom and transfer the electricity to the plurality of sockets.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a top perspective view of a multiple socket electrical outlet device in accordance with an embodiment of the present invention;

FIG. 2 is a side perspective view of the multiple socket electrical outlet device of FIG. 1;

FIG. 3 is a schematic cross section view of the multiple electrical outlet device of FIG. 1;

FIG. 4 is a side perspective view of the multiple socket electrical outlet device of FIG. 1 with a plurality of power adapters and transformers plugged into a plurality of sockets or outlets;

FIG. 5 is a side perspective view of the multiple socket electrical outlet device of FIG. 1, with an electrical power cord;

FIG. 6 is a top perspective view of the multiple socket electrical outlet device of FIG. 5, with a plurality of power adapters and transformers plugged into a plurality of sockets or outlets;

FIG. 7 is a top perspective view of a multiple socket electrical outlet device in accordance with another embodiment of the present invention, with switch having a surge/spike protector;

FIG. 8 is a top perspective view of a multiple socket electrical outlet device in accordance with another embodiment of the present invention, with an additional electrical socket in a top plate;

FIG. 9a is a bottom perspective view of a multiple socket electrical outlet device in accordance with another embodiment of the present invention, with a pair of plugs in a bottom plate;

FIG. 9b is a side perspective view of the multiple socket electrical outlet device of FIG. 9a;

FIG. 10 is a bottom perspective view of a multiple socket electrical outlet device in accordance with another embodiment of the present invention, with an switch having a surge/spike protector in a bottom plate;

FIG. 11 is a top perspective view of a multiple socket electrical outlet device in accordance with another embodiment of the present invention; and

FIG. 12 is a side perspective view of a multiple socket electrical outlet device in accordance with another embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As used herein, “electrical socket” refers to a female electrical connector and “electrical plug” refers to a male electrical connector. Accordingly, an electrical socket has slots or holes which accept the pins, poles, or blades of an electrical power plug. With the male plug inserted into the female socket, electricity is delivered from the socket to the plug. For purposes of this description, the terms “socket”, “outlet”, and “receptacle” are interchangeable terms. Additionally, the terms “plug”, “adapter”, and “transformer” are interchangeable terms.

Non-limiting examples of suitable electrical sockets can include all multi-holed electricity delivering outlets such as two hole, grounded three hole, single and double pole outlets, three hole sockets, and four hole sockets. Non-limiting examples of suitable electrical plugs can include the male counterparts to the afore mentioned sockets, including standard plug, adapter, and transformer type male electrical connectors. Additionally, the sockets and plugs described herein can deliver and receive AC electrical power or DC electrical power. Moreover, the sockets and plugs may be configured for standardized electrical power plugs from different countries, such as plugs with blades as commonly used in the United States, or plugs with pins or prongs as commonly used in the United Kingdom. While many types of sockets can benefit from the principles described herein, for simplicity, and by way of example, a standard 110 volt AC single pole grounded electrical receptacle having a pair of polarized plug slots and a single ground hole, as commonly used in the United States, is discussed below and shown in the FIGs.

The embodiments of the present invention described herein provide generally for a multiple electrical socket device. The multiple electrical socket device can have a bell-shaped housing with a domed upper end or top, an outwardly flared lower end, and an arcuate sidewall extending between the dome shaped upper end and the outwardly flared lower end. The side wall can form a perimeter around the housing. A plurality of protrusions can extend outward from the sidewall. Each of the protrusions can have an electrical socket disposed in a face of the protrusion to form a loop of electrical sockets with each electrical socket facing a different radial direction around the loop. Additionally, the protrusions can be positioned on the sidewall such that the arcuate sidewall forms a depression between each of the protrusions. The depression can be sized, shaped, and positioned to allow a user to grasp an adapter or transformer plugged into one of the sockets at approximately the location of the plug prongs. In this way, the depression can facilitate grasping and removing the adapter or transformer from the socket.

The protrusions can also be spaced around the side wall so as to minimize contact or interference between adjacent adapters or transformers that are plugged into the electrical sockets. Additionally, the electrical sockets can be oriented with the grounding pole in an upward position with respect to the neutral and hot leads such that the electrical cords extending from adapters or transformers that are plugged into the electrical sockets generally extend upward and away from the multiple socket device.

A space can be formed inside the loop of electrical sockets that can be sized and shaped to receive an electricity management device such as an electrical socket, an extension cord, a plug, a surge/spike protector, and the like. The electricity management device can extend through a top plate that covers the space on the top of the housing and/or a bottom plate that covers the space on the bottom of the housing.

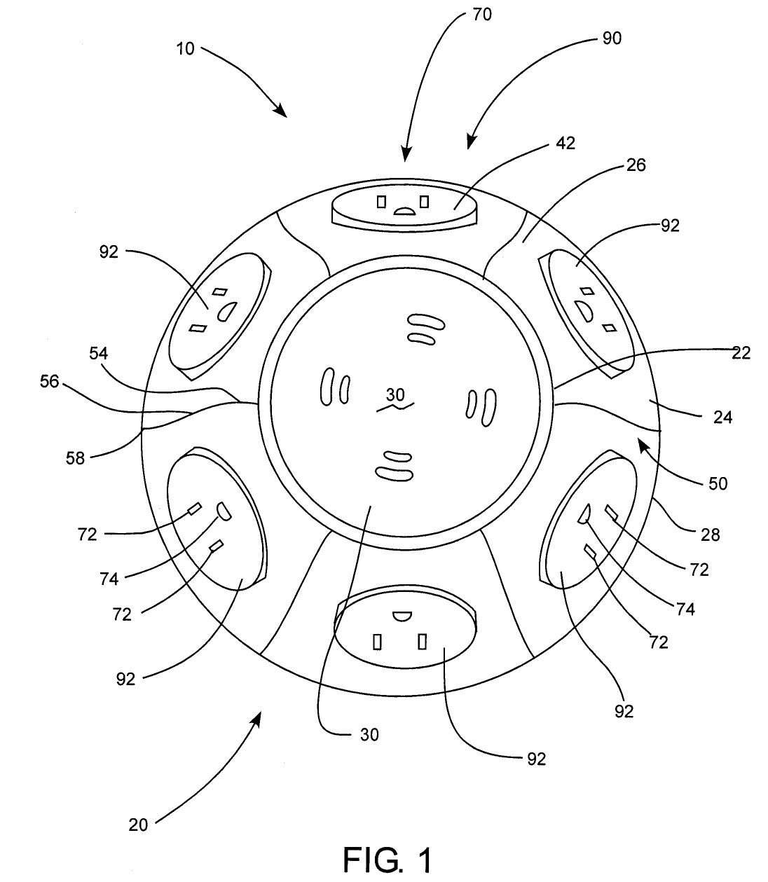

As illustrated in FIG. 1-4, a multiple electrical socket device, indicated generally at 10, is shown in accordance with an embodiment of the present invention for use in increasing the number of electrical outlets available to power electronic devices or appliances. The multiple electrical socket device 10 can include a bell shaped housing, indicated generally at 20, formed by an arcuate sidewall, indicated generally at 50, and a plurality of electrical sockets, indicated generally at 70, on a plurality of protrusions, indicated generally at 90, extending outwardly from the arcuate sidewall 50 of the bell shaped housing. In use, the plurality of electrical sockets 70 can be electrically coupled to a single outlet or socket and power can be transferred from the single socket to all of the sockets in the plurality of sockets 70 in the bell shaped housing 20. In this way, the multiple socket device 10 can increase the number of sockets available for use.

The bell-shaped housing 20 can be formed of a polymer or plastic material, and can have a domed upper end 22, and an outwardly flared lower end 24. The arcuate side wall 50 can form the bell shaped housing 20 and can extend between the domed upper end 22 and the outwardly flared lower end 24. The arcuate side wall 50 can form a perimeter 28 around the bell-shaped housing 20.

The upper end 22 of the bell shaped housing can have a top plate 30 that forms an upper end 12 of the electrical socket device 10. The top plate 30 can cover a space 100 inside the perimeter 28 of the housing. A bottom plate 34 can be coupled to the lower end 24 of the bell shaped housing 20. The bottom plate 34 can cover the space 100 on the lower end 14 of the electrical socket device 10. The top plate 30 and the bottom plate 34 can be monolithically formed with the bell shaped housing 20, or can be separate component attached to the bell shaped housing.

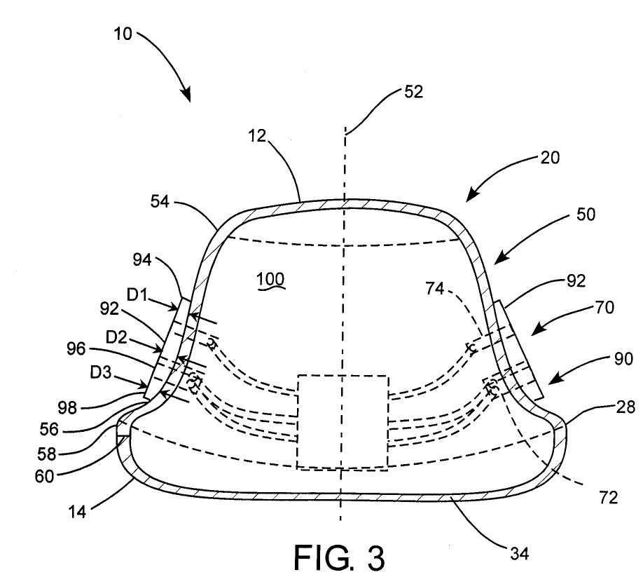

In profile, as best seen in FIG. 3, the arcuate side wall 50 can extend downwardly and outwardly with respect to a centerline of the housing, indicated by the dashed line at 52, from the domed upper end 22 to an upper corner 54. At the upper corner 54, the side wall 50 turns to a steeper downward direction and extends downwardly from the upper corner 54 in a steeper downward direction to an inner lower corner 56 where the side wall turns in an outward direction. The side wall 50 can extend downwardly in a less steep direction and outwardly from the inner lower corner 56 to an outer lower corner 58 where the side wall turns downward again. The side wall 50 can extend downwardly from the outer lower corner 58 to a lower termination point 60 of the bell shaped housing 20. The bottom plate 34 can be coupled to the lower termination point 60 of the bell shaped housing to close of the lower end 14 of the electrical socket device 10.

The plurality of protrusions 90 can be formed in the arcuate side wall 50 between the dome shaped upper end 22 and the outwardly flared lower end 24. Each of the protrusions 90 can extend outwardly from the arcuate side wall 50 around the perimeter 28 of the bell shaped housing 20 to a face 92. The face 92 can be a substantially flat surface extending across the top of the protrusion 90 and can be sized to accommodate placement of an electrical socket 70.

The plurality of protrusions 90 can have a shape that is conducive to removal of electrical plugs 8 that are plugged into the electrical socket 70 disposed in the protrusion and accessible from the face 92 of the protrusion 90. For example, in one embodiment, the protrusions 90 can be cylindrically shaped, as seen in FIGS. 1-4. Advantageously, cylindrically shaped protrusions can minimize surface area contact between a plug-in electrical transformer head 8 and the face 92 of the protrusion 90 when the transformer is plugged into the socket 70. Additionally, the size of the cylindrical protrusion 90 can allow corners 5 of normally quadrangular shaped transformer heads 8 to extend beyond the face of the protrusion 90 making the corners of the transformer head 8 easier to grasp. In this way, the shape and spacing of the protrusions 90 can facilitate grasping and removing the transformer from the socket 70.

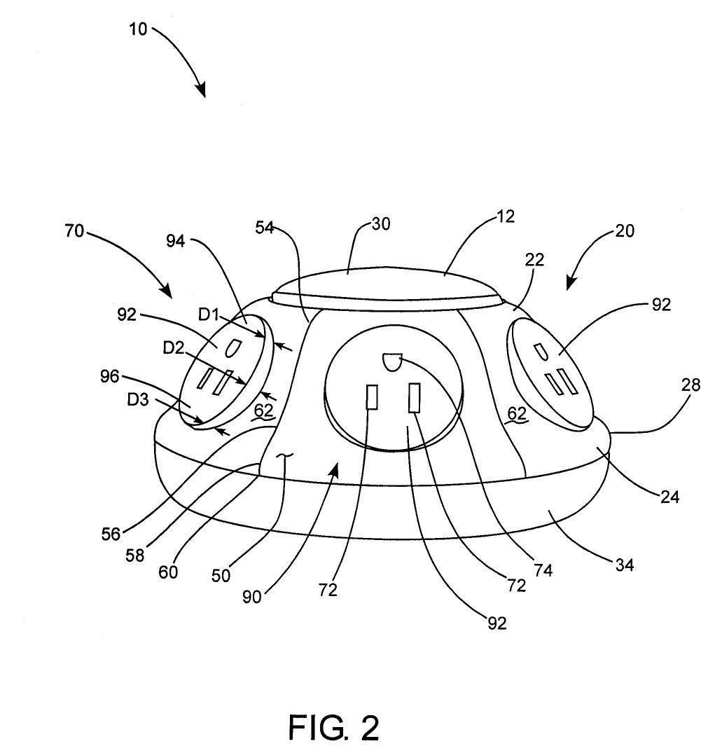

Additionally, the protrusions 90 can be positioned and oriented on the arcuate side wall 50 to facilitate use of the socket 70. For example, the protrusions 90 can be spaced apart around the perimeter 28 so as to allow a user to place fingers between each of the protrusions 90 in order to better grasp a transformer or adapter head 8 plugged into a socket 70. Additionally, the protrusions 90 can be positioned on the arcuate side wall 50 closer to the outwardly flared lower end 24 than the upper domed end 22, and the face 92 of the protrusion can be angled with respect to the centerline 52 such that a trough or depression 62 is formed in the sidewall 50 between the protrusions 90. Thus, as best illustrated in FIGS. 2-3, the protrusions 90 can be positioned and angled with respect to the arcuate sidewall 50 such that the distance D1 between the side wall 50 and the face 92 at an upper end 94 of the protrusion is relatively smaller than the distance D2 between the arcuate sidewall 50 and the face 92 at an intermediate portion 96 of the protrusion 90. Similarly, the distance D3 between the arcuate side wall 50 and the face 92 at a lower end 98 of the protrusion is relatively smaller than the distance D2 between the arcuate sidewall 50 and the face 92 at the intermediate portion 96 of the protrusion 90. In this way, the arcuate sidewall 50 can form the depression 62 in relation to the face 92 of the protrusions that extends between each of the protrusions 90.

The depression 62 can be sized, shaped and positioned in relation to the protrusion 90 so as to provide a space or distance D3 between the face 92 of each of the plurality of protrusions 90 and the arcuate side wall 50 in order to facilitate removal of an electrical plug-in transformer from the electrical socket. It will be appreciated that many plug-in transformers and adapters have a relatively large head 8 with respect to the plug face of the socket, and may include a grounding pole or prong in addition to the hot and neutral poles or prongs. Because of the size and number of the prongs of the plug, these transformers and adapters can be difficult to remove from a socket due to the increased resistance of additional prongs and space constraints around the transformer head.

Thus, it is a particular advantage of the embodiment of the multiple electrical socket device 10 described herein that the depression 62 provides a space or distance D3 between the transformer head 8 and the face 92 of the protrusion 90 that allows a user to grasp around and underneath the transformer head 8 in order to apply additional force in removing the transformer head 8 from the electrical socket 70. Additionally, the depression 62 can be positioned at an elevation along the arcuate sidewall 50 that is substantially the same as an elevation of the pair of flat blade slots 72 in each of the electrical sockets 70 that correspond to the hot and neutral prongs or pins (not shown) of the transformer plug 8.

The depression 62 can also have a smoothly contoured surface so as to minimize sharp edges and corners in the space or distance D3 between each of the plurality of protrusions 90 and the arcuate side wall 50. In this way, as a user grasps a transformer head 8 the user will not encounter any sharp edges in the depression 62.

The perimeter 28 of the bell shaped housing 20 can also have a shape that facilitates spacing of the plurality of electrical sockets 70 around the housing. For example, in one aspect, the perimeter 28 of the housing can be substantially circular, as shown in FIGS. 1-4. It will be appreciated that the protrusions 90 on a circular shaped perimeter can be substantially equally spaced around the perimeter 28 such that the face 92 of each protrusion 90 can be oriented in a different radial or angular direction with respect to the centerline of the housing. In this way, the electrical socket 70 in each face 92 can also be oriented in a different radial direction.

Other perimeter shapes can also be used for the shape of the housing in order to face each of the electrical sockets at different angular spacing with respect to one another. For example, in another aspect, the housing 20 can be hexagonal, and each of the electrical outlets 42 can face outwardly on one of the sides of the hexagon. In the hexagonal case, the plurality of outlets can include six outlets oriented with a substantially equally angular spacing of approximately 60 degrees. In another aspect, the housing 20 can be quadrangular and each of the electrical outlets can face outwardly on one of the four sides of the quadrangular shape at a substantially equal spacing of approximately 90 degrees with respect to one another.

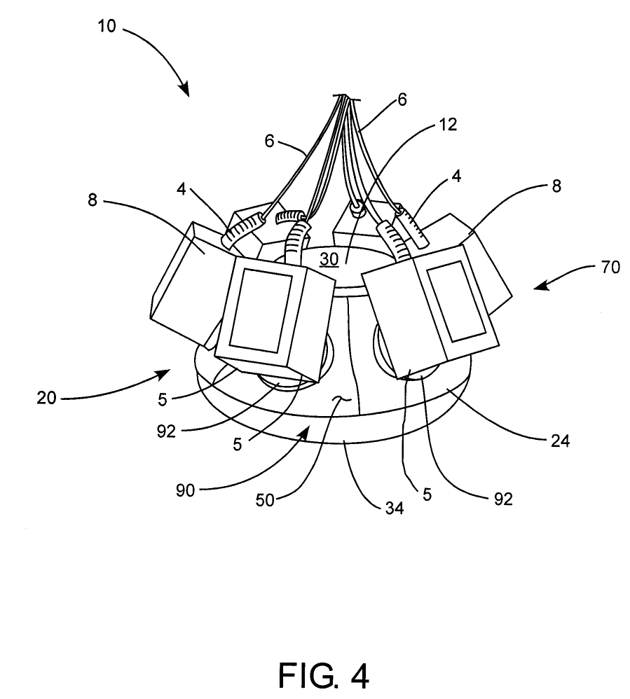

It is advantageous of the embodiments of the multiple electrical socket device 10 described herein that each of the electrical sockets 70 faces a different radial direction. It will be appreciated that the head size of some transformers and adapters may be large enough that when the transformer or adapter is plugged into a traditional, linearly-aligned, multiple-plug, power strip or surge suppressor the transformer head may cover adjacent electrical sockets so that they are inaccessible. Unfortunately, when this occurs, the total number of available plugs in the power strip is reduced. Thus, it is a particular advantage of the embodiments of the present invention described herein that the electrical sockets 70 can be disposed on the perimeter 28 of the housing 20 with each socket 70 facing a different direction because this configuration spaces and orients each socket 70 such that a transformer or power adapter can be plugged into each of the sockets 70 without interfering with the adjacent sockets. Thus, as shown in FIG. 4, each socket in the plurality of sockets can be utilized simultaneously.

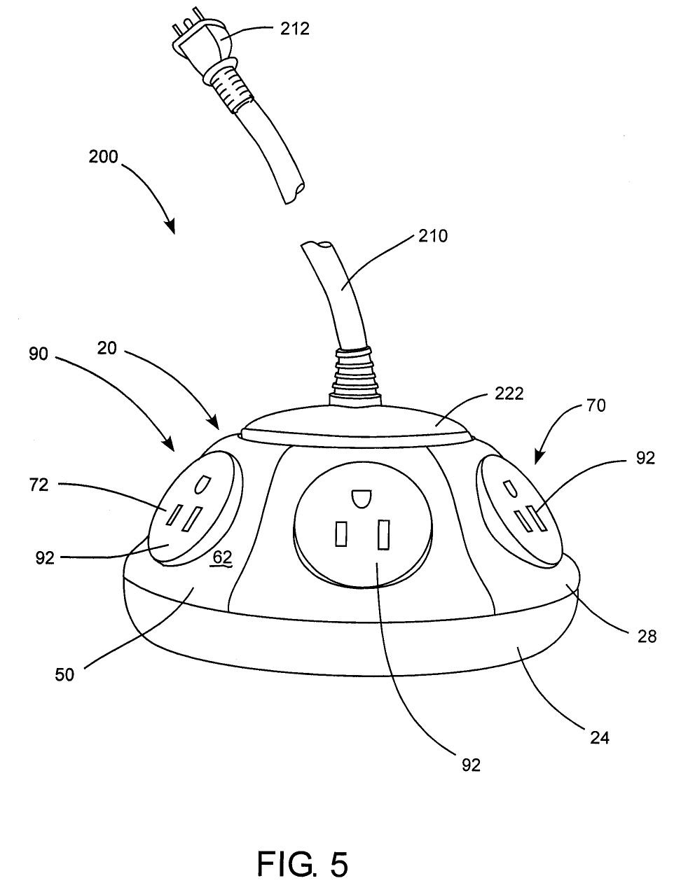

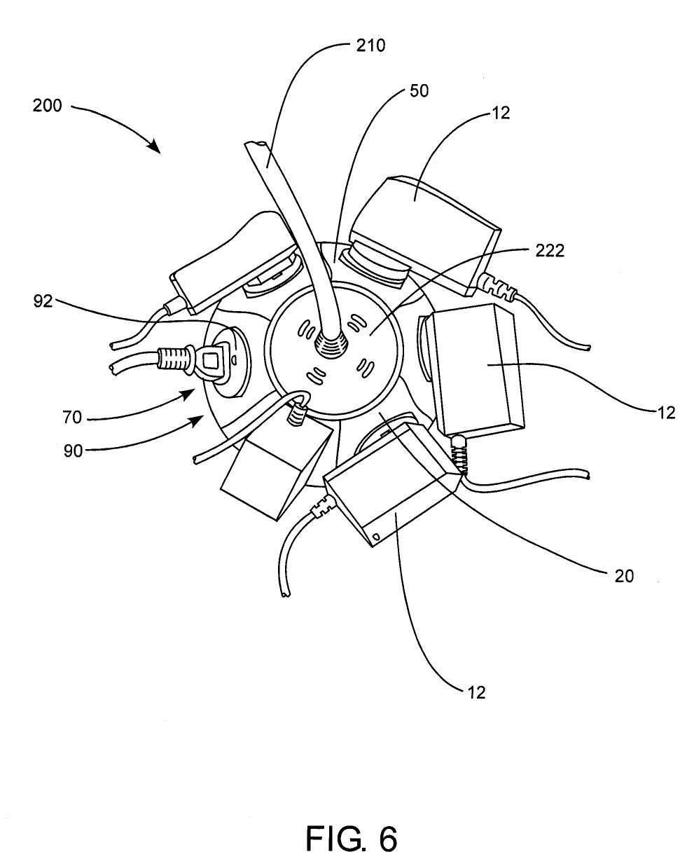

As shown in FIGS. 5-6, a multiple electrical socket device, indicated generally at 200, is shown in accordance with another embodiment of the present invention for use in increasing the number of electrical outlets available to power electronic devices or appliances. The multiple electrical socket device 200 can be similar in many respects to the multiple electrical socket device 10 described above and shown in FIGs.1 -4. Thus, the multiple electrical socket device 200 can include a bell shaped housing, indicated generally at 20, formed by an arcuate sidewall, indicated generally at 50, and a plurality of electrical sockets, indicated generally at 70, on a plurality of protrusions, indicated generally at 90, extending outwardly from the arcuate sidewall 50 of the bell shaped housing. A depression 62 can be formed by the arcuate sidewall between the face 92 of each of the protrusions 90 and the sidewall 50.

Additionally, the multiple electrical socket device 200 can include a power extension cord 210 electrically coupled to the plurality of electrical sockets 70. The extension cord 210 can extend through the top plate 222. The extension cord 210 can have a plug 212 on a distal end that can be inserted into an electrical power receptacle to provide power from the electrical power receptacle to the plurality of electrical sockets. Advantageously, the extension cord 210 extending from the top of the multiple electrical socket device 200 is easier to keep free from tangles with the power cords plugged into the plurality of sockets 70 in the bell shaped housing 20.

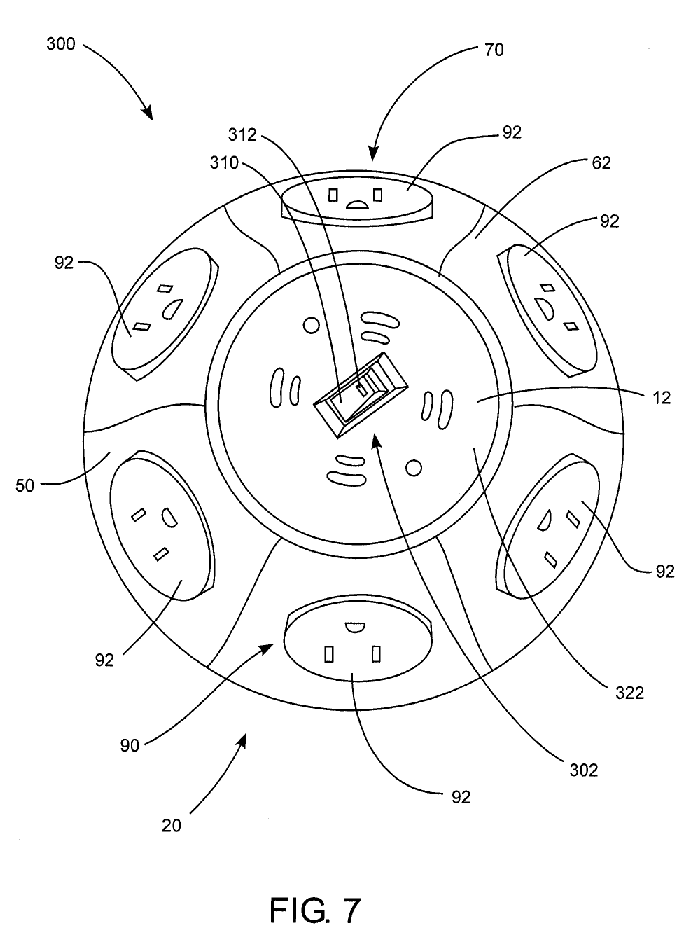

As shown in FIG. 7, a multiple electrical socket device, indicated generally at 300, is shown in accordance with another embodiment of the present invention for use in increasing the number of electrical outlets available to power electronic devices or appliances. The multiple electrical socket device 300 can be similar in many respects to the multiple electrical socket device 10 described above and shown in FIGS. 1-4. Thus, the multiple electrical socket device 300 can include a bell shaped housing, indicated generally at 20, formed by an arcuate sidewall, indicated generally at 50, and a plurality of electrical sockets, indicated generally at 70, on a plurality of protrusions, indicated generally at 90, extending outwardly from the arcuate sidewall 50 of the bell shaped housing. A depression 62 can be formed by the arcuate sidewall between the face 92 of each of the protrusions 90 and the sidewall 50.

Additionally, the multiple electrical socket device can include an electricity control device, indicated generally at 302. The electricity control device 302 can include an on-off switch 310 in the top plate 322 on the top 12 of the bell shaped housing 20. In one aspect, the on-off switch 310 can also be an electrical surge/spike protector 70. The switch 310 can have a reset switch 312 that is accessible by the user to reset the surge protector in the event the protector is tripped by a power surge or spike. In one aspect, the surge/spike protector can include a circuit breaker or other electrical interrupt device as known in the art.

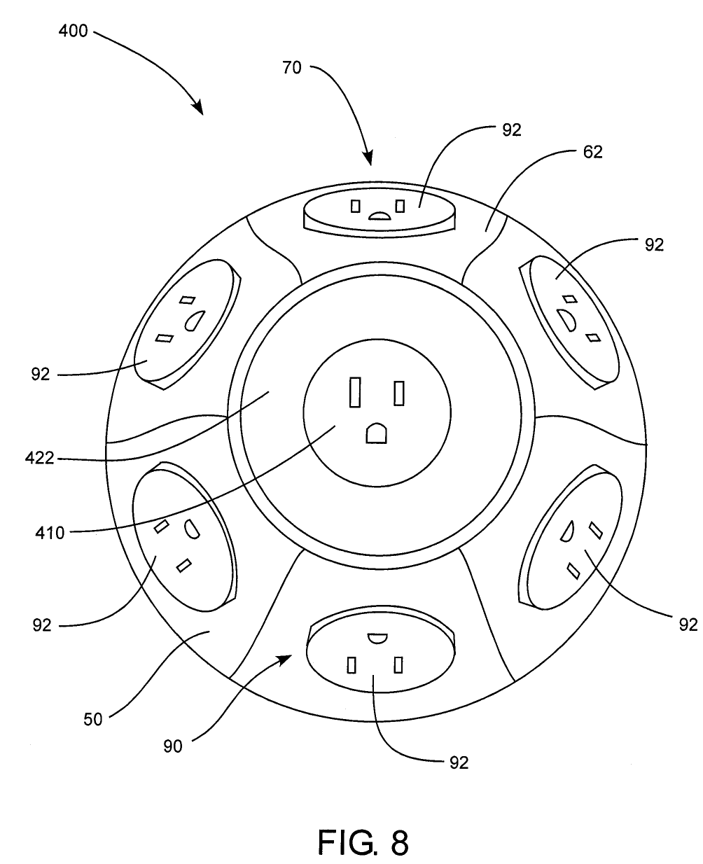

As shown in FIG. 8, a multiple electrical socket device, indicated generally at 400, is shown in accordance with another embodiment of the present invention for use in increasing the number of electrical outlets available to power electronic devices or appliances. The multiple electrical socket device 400 can be similar in many respects to the multiple electrical socket device 10 described above and shown in FIGS. 1-4. Thus, the multiple electrical socket device 400 can include a bell shaped housing, indicated generally at 20, formed by an arcuate sidewall, indicated generally at 50, and a plurality of electrical sockets, indicated generally at 70, on a plurality of protrusions, indicated generally at 90, extending outwardly from the arcuate sidewall 50 of the bell shaped housing. A depression 62 can be formed by the arcuate sidewall between the face 92 of each of the protrusions 90 and the sidewall 50.

Additionally, the multiple electrical socket device 400 can include an electrical socket 410 disposed in the top plate 422. In one aspect, the electrical socket 410 can be electrically coupled to the plurality of sockets 70 to provide electrical power to the plurality of sockets. In another aspect, the electrical socket 422 can be electrically coupled to a common power supply that supplies power to the plurality of electrical sockets 40 and can thus operate as an additional electrical socket in the multiple electrical socket device 400.

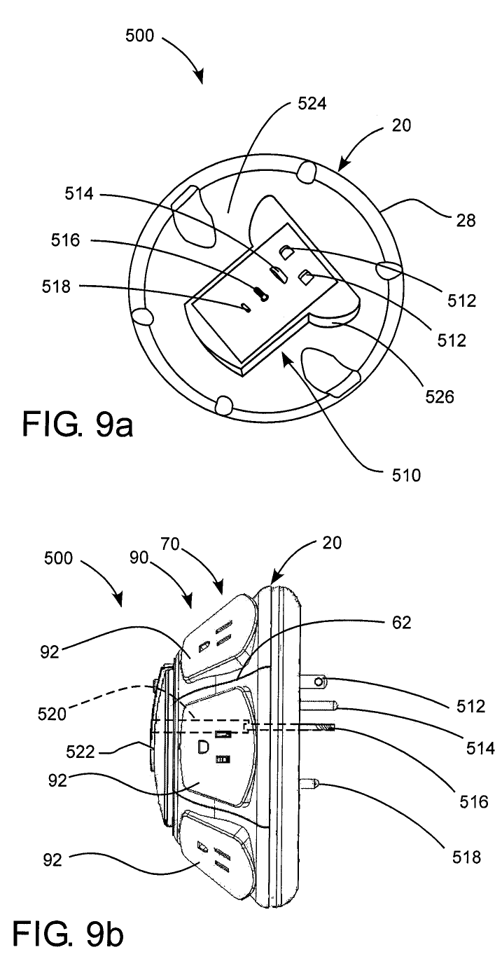

As shown in FIGS. 9a-9b, a multiple electrical socket device, indicated generally at 500, is shown in accordance with another embodiment of the present invention for use in increasing the number of electrical outlets available to power electronic devices or appliances. The multiple electrical socket device 500 can be similar in many respects to the multiple electrical socket device 10 described above and shown in FIGs.1-4. Thus, the multiple electrical socket device 500 can include a bell shaped housing, indicated generally at 20, formed by an arcuate sidewall, indicated generally at 50, and a plurality of electrical sockets, indicated generally at 70, on a plurality of protrusions, indicated generally at 90, extending outwardly from the arcuate sidewall 50 of the bell shaped housing. A depression 62 can be formed by the arcuate sidewall between the face 92 of each of the protrusions 90 and the sidewall 50.

Additionally, the multiple electrical socket device 500 can include a male plug, indicated generally at 510, that can be plugged into a female wall outlet or receptacle. In one aspect, the plug 510 can include a pair of plugs 512 and a grounding prong 514 that can extend on a protrusion 526 through a bowl-shaped bottom plate 524. The pair of plugs 512 and grounding prong 514 can be configured to plug into a wall outlet or receptacle. Advantageously, the bottom mounted plug 510 eliminates a cord-based extension cord and plug that can become entangled with cords from transformers plugged into the plurality of electrical sockets.

The bottom protrusion 526 can also include a mounting screw 516 extending from the body of the multiple socket device 500. The screw 516 can be screwed into a receiving screw hole in the wall receptacle so as to secure the wall mounted socket device 500 to the wall receptacle. The screw can be accessed from the top 522 of the multiple socket device 500 through a hole 520 extending into the body of the multiple socket device 500.

Moreover, the bottom protrusion 526 can also include a pin 518 formed with the protrusion 526 and extending away therefrom. The pin 518 can be sized and shaped to fit within a grounding hole of an adjacent electrical plug in the wall receptacle. Thus, when the multiple socket device 500 is mounted to a wall receptacle, the pair of plugs 512 and grounding prong 514 can be received by one of the electrical outlets of the wall receptacle, the screw 516 can secure the multiple socket device to the wall receptacle, and the pin 518 can be received by the grounding hole of the other electrical outlet, and can restrict rotation of the multiple socket device 500 around the screw 516.

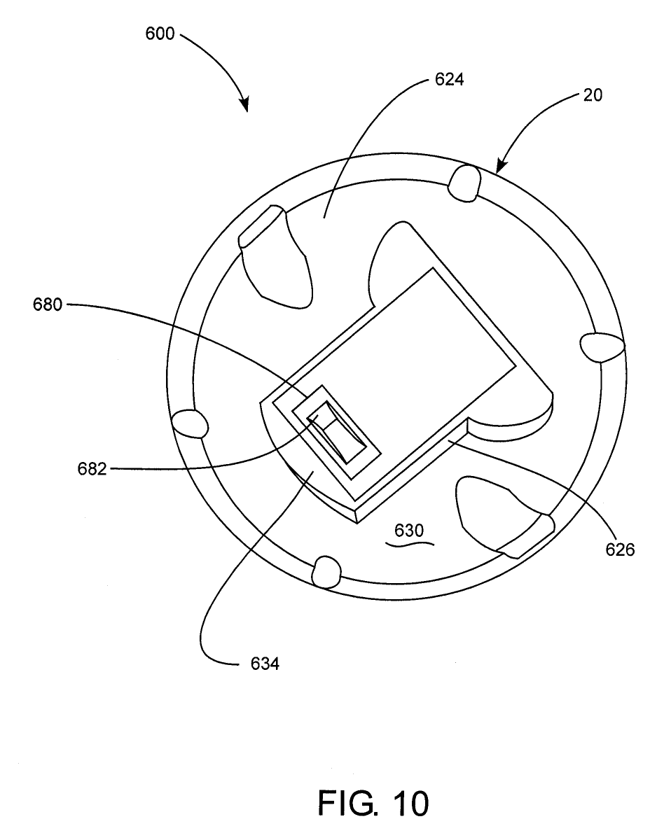

As shown in FIG. 10, a multiple electrical socket device, indicated generally at 600, is shown in accordance with another embodiment of the present invention for use in increasing the number of electrical outlets available to power electronic devices or appliances. The multiple electrical socket device 600 can be similar in many respects to the multiple electrical socket device 10 described above and shown in FIGS. 1-4. Thus, the multiple electrical socket device 600 can include a bell shaped housing, indicated generally at 20, formed by an arcuate sidewall (not shown), and a plurality of electrical sockets (not shown), on a plurality of protrusions (not shown), extending outwardly from the arcuate sidewall of the bell shaped housing. A depression (not shown) can be formed by the arcuate sidewall between the face of each of the protrusions and the sidewall.

Additionally, the multiple electrical socket device 600 can include an electrical surge/spike protector 680. The electrical surge/spike protector 600 is an example of an electricity control device that controls or regulates the flow of electricity to the plurality of electrical sockets. The surge/spike protector 680 can have a reset switch 682 disposed on a bottom plate 634 on a protrusion 626 that extends away from a bowl-shaped bottom 624 of the housing. The switch 682 can be positioned to be accessible by the user to reset the surge protector in the event the protector is tripped by a power surge or spike. The protrusion 626 can also position the switch within the bowl area 630 of the bowl-shaped bottom 624 so the switch 682 will not be inadvertently tripped by a support surface when the multiple electrical socket device 600 is resting on the bowl-shaped bottom 624.

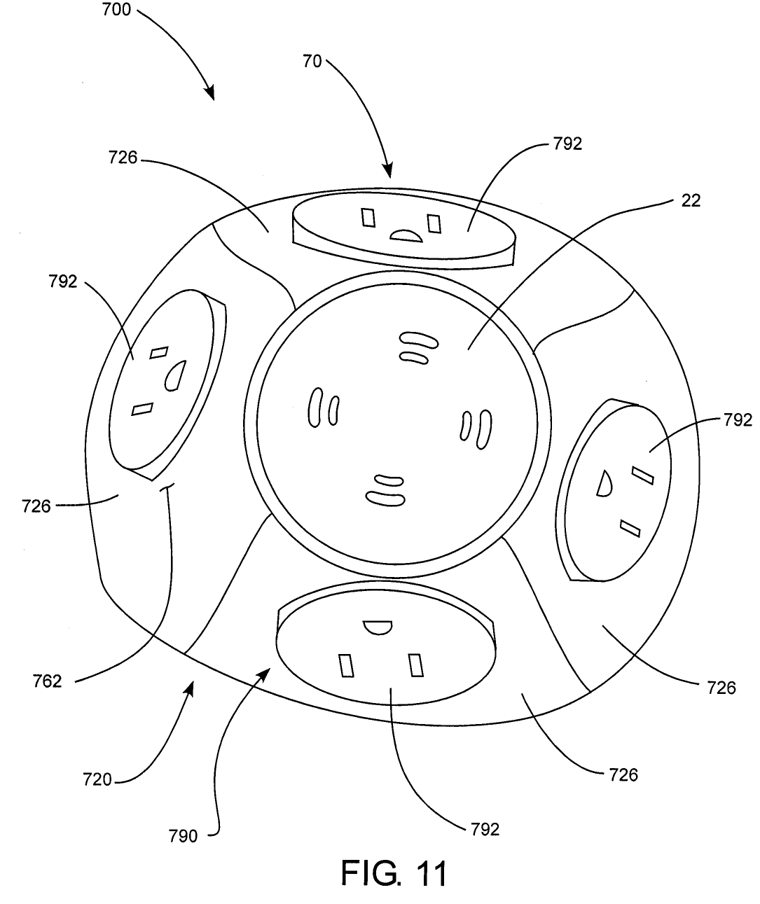

As shown in FIG. 11, a multiple electrical socket device, indicated generally at 700, is shown in accordance with another embodiment of the present invention for use in increasing the number of electrical outlets available to power electronic devices or appliances. The multiple electrical socket device 700 can be similar in many respects to the multiple electrical socket device 10 described above and shown in FIGS. 1 -4. The multiple electrical socket device 700 can include a bell shaped housing, indicated generally at 720, formed by an arcuate sidewall, indicated generally at 750, and a plurality of electrical sockets, indicated generally at 70, on a plurality of protrusions, indicated generally at 790, extending outwardly from the arcuate sidewall 750 of the bell shaped housing. A depression 762 can be formed by the arcuate sidewall between the face 792 of each of the protrusions 790 and the sidewall 750.

Additionally, the plurality of sockets 70 can include four sockets, and the shape of the perimeter 728 of the housing 720 can be substantially quadrangular. In this embodiment, each of the sides 726 of the quadrangular shape can have a protrusion 790 with an electrical socket 70 facing outward from the housing 720.

It will be appreciated that the perimeter the housing of the multiple socket devices described herein can have other polygonal shapes depending on how many electrical sockets are needed or desired. Thus, the shape of the housing can correspond to the number of electrical sockets with a socket disposed on each side of the shape. For example, the perimeter can have other shapes, such as a triangular shape with three sockets, a pentagonal shape with five sockets, a hexagonal shape with six sockets, and the like.

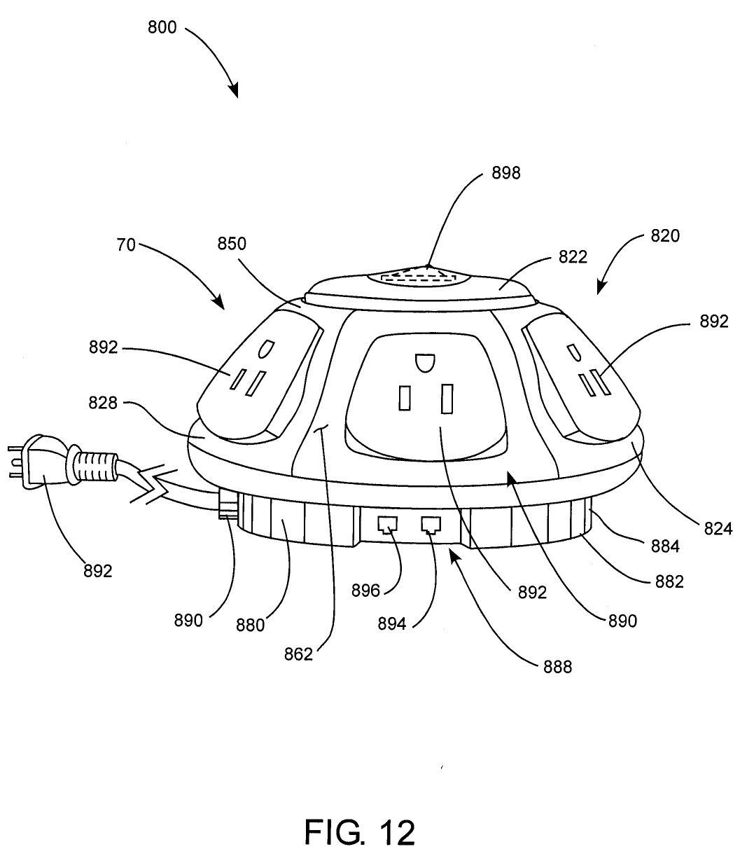

As shown in FIG. 12, a multiple electrical socket device, indicated generally at 800, is shown in accordance with another embodiment of the present invention for use in increasing the number of electrical outlets available to power electronic devices or appliances. The multiple electrical socket device 800 can be similar in many respects to the multiple electrical socket device 10 described above and shown in FIGS. 1-4. The multiple electrical socket device 800 can include a bell shaped housing, indicated generally at 820, formed by an arcuate sidewall, indicated generally at 850, and a plurality of electrical sockets, indicated generally at 70, on a plurality of protrusions, indicated generally at 890, extending outwardly from the arcuate sidewall 850 of the bell shaped housing. A depression 862 can be formed by the arcuate sidewall between the face 892 of each of the protrusions 890 and the sidewall 850.

The protrusions 890 can be quadrangular in shape, and an electrical socket 870 can be disposed on the face 892 of the protrusion. Because the protrusions are spaced around the perimeter 828 of the housing 820, each of the faces 892 of the protrusions 890 can face a different angular orientation. Hence, each of the electrical sockets 70 can face in a different angular orientation which minimizes interference between transformers plugged into each of the electrical sockets.

The multiple electrical socket device 800 can also include a base 880 disposed under the outwardly flared lower end 824 of the bell shaped housing 820. The base 880 can have a perimeter 882 that is relatively smaller than the perimeter 828 of the flared lower end 824. The base 882 can also include a power cord 890 extending from a side 884 of the base. The power cord 890 can be electrically coupled to the sockets 70. The power cord 890 can have a male plug end 892 that can be coupled a power supply, such as a wall socket or receptacle in order to provide power to the sockets 870.

The base 890 can also include at least one electronic data communication port 888. In one aspect, the data communication port, indicated generally at 888, can be an audio-visual communication port. For example, the data communication port 888 can be a telephone audio jack 894, a telephone data jack 896, a coaxial data jack (not shown), an RCA jack (not shown), an S-video jack (not shown), a TRS jack (not shown), and the like. Telephone or data cables (not shown) can be plugged into the port 888 and route or split electronic information that can be used by multiple receiving stations at remote locations away from the multiple electrical socket device 800. In this way, the multiple electrical socket device 800 can operate as a communications hub or bus.

The multiple electronic socket device can also include a switch 898 disposed in a top plate 822. The switch 898 can be an on/off switch and can also include a power surge/spike protector. The switch 898 is an example of an electricity control device that controls or regulates the flow of electricity to the electrical outlets 70.

The present invention also provides for a method for powering multiple power adapters/transformers including electrically coupling a multi-socket electrical outlet device to an electrical power supply to provide electricity to the plurality of electrical sockets. The plurality of electrical sockets can be disposed about a perimeter loop of the electrical outlet device. A plurality of adapters/transformers can be plugged into the plurality of electrical sockets. Each adapter/transformer can be plugged into a different electrical socket. Additionally, each socket can be oriented and spaced apart from adjacent sockets to provide sufficient room between the sockets to reduce interference between adjacent adapters/transformers.

It will be appreciated that the embodiments of the multiple socket electrical outlet devices described herein can also come in a variety of sizes, shapes and colors. In this way, housing can be designed to fit within an existing design or color scheme. For example, the housing can be green, blue, yellow, red, or the like.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A multiple electrical socket device, comprising:
a) a bell shaped housing having an arcuate side wall with a domed upper end and a outwardly flared lower end, the arcuate sidewall forming a perimeter around the bell shaped housing;
b) a plurality of protrusions extending away from the sidewall, each of the protrusions having a face oriented in a different radial direction around the perimeter of the bell shaped housing;
c) a plurality of electrical sockets, each socket disposed in a different face of the plurality of protrusions and each socket configured to receive an electrical plug; and
d) the plurality of protrusions positioned on the sidewall between the domed upper end and the outwardly flared lower end to form a depression between the arcuate side wall and each of the plurality of protrusions with the depression extending between each of the protrusions.

2. A device in accordance with claim 1, wherein the depression is sized and shaped to provide a space between the face of each of the plurality of protrusions and the arcuate side wall to facilitate removal of an electrical plug-in transformer from the electrical socket.

3. A device in accordance with claim 2, wherein the depression has a smoothly contoured surface to minimize sharp edges and corners in the space between each of the plurality of protrusions and the arcuate side wall.

4. A device in accordance with claim 1, wherein the depression is positioned at an elevation substantially the same as an elevation of a pair of flat prong receptacles in each of the electrical sockets.

5. A device in accordance with claim 1, further comprising a power cord electrically coupled to each of the electrical sockets and extending through the upper end, the power cord having a male plug on a distal end insertable into an electrical power receptacle to provide power from the electrical power receptacle to the plurality of electrical sockets.

6. A device in accordance with claim 1, further comprising a male electrical plug electrically coupled to the each of the electrical sockets and disposed in the lower end, the electrical plug being configured to plug into an electrical power receptacle to receive electricity therefrom and transfer the electricity to the plurality of sockets.

7. A device in accordance with claim 1, wherein each of the plurality of protrusions are cylindrically shaped to minimize surface area contact between a plug-in electrical transformer and the face of the protrusion when the transformer is plugged into the socket to facilitate grasping and removing the transformer from the socket.

8. A device in accordance with claim 1, further comprising a base disposed under the outwardly flared lower end, and having a perimeter relatively smaller than the flared lower end.

9. A device in accordance with claim 8, wherein the base further includes a power cord extending from a side of the base and electrically coupled to the sockets, the power cord being coupleable to a power supply to provide power to the sockets.

10. A device in accordance with claim 8, wherein the base further includes at least one audio-visual communication port.

11. A device in accordance with claim 1, further comprising an electricity control device, disposed in a space between the electrical sockets, configured to manage or control the flow of electricity to the plurality of sockets.

12. A device in accordance with claim 11, wherein the electricity control device includes an electrical surge/spike protector with a power/reset switch accessible by a user.

13. A device in accordance with claim 1, wherein each of the electrical sockets is oriented on the respective face of the respective protrusion so as to orient an electrical cord coupled to an electrical transformer plugged into the electrical socket in an upwardly extending position.

14. A multiple socket electrical outlet device, comprising:
a) a bell shaped housing having a domed upper end, an outwardly flared lower end, and an arcuate side wall therebetween forming a perimeter of the bell shaped housing;
b) a plurality of electrical sockets, each socket extending away from the arcuate sidewall in a different radial direction on the perimeter; and
c) a base disposed under the outwardly flared lower end, and having a perimeter relatively smaller than the flared lower end.

15. A device in accordance with claim 14, wherein the base further includes a power cord extending from a side of the base and electrically coupled to the sockets, the power cord being coupleable to a power supply to provide power to the sockets.

16. A device in accordance with claim 14, wherein the base further includes at least one audio-visual communication port.

17. A device in accordance with claim 14, wherein each of the electrical sockets is positioned on the sidewall between the upper end and the flared lower end, and the arcuate profile defining a depression extending between each of the cylindrical protrusions.

18. A device in accordance with claim 17, wherein the depression is sized and shaped to provide a space between a face of each of the electrical sockets and the arcuate side wall to facilitate removal of a plug-in transformer from the electrical socket.

19. A device in accordance with claim 14, further comprising a male electrical plug electrically coupled to the each of the electrical sockets and disposed in the base, the electrical plug being configured to plug into an electrical power receptacle to receive electricity therefrom and transfer the electricity to the plurality of sockets.

20. A multiple socket electrical outlet device, comprising:
a) a bell shaped housing having a domed upper end, an outwardly flared lower end, and an arcuate side wall therebetween forming a perimeter of the bell shaped housing;
b) a plurality of electrical sockets, each socket extending away from the arcuate sidewall in a different radial direction on the perimeter; and
c) a male electrical plug electrically coupled to the plurality of sockets and disposed in the lower end, the electrical plug being configured to plug into an electrical power receptacle to receive electricity therefrom and transfer the electricity to the plurality of sockets.

21. A device in accordance with claim 20, wherein each of the electrical sockets is positioned on the sidewall between the upper end and the flared lower end, and the arcuate profile defining a depression extending between each of the cylindrical protrusions.

22. A device in accordance with claim 21, wherein the depression is sized and shaped to provide a space between the each of the electrical sockets and the arcuate side wall to facilitate removal of the plug-in transformer from the electrical socket.

23. A device in accordance with claim 20, further including a base disposed under the outwardly flared lower end, and having a perimeter relatively smaller than the flared lower end, and a power cord extending from a side of the base that is electrically coupled to the sockets, the power cord being coupleable to a power supply to provide power to the sockets.
